(19) United States
(12) Patent Application Publication
(10) Pub. No.: US 2015/0204231 A1
(43) Pub. Date: Jul. 23, 2015

(54) SYSTEM FOR PRESSURIZING A COOLING CIRCUIT OF AN INTERNAL COMBUSTION ENGINE EQUIPPED WITH A TURBOCOMPRESSOR UNIT

(71) Applicant: FPT Industrial S.p.A., Torino (IT)

(72) Inventors: Giancarlo Dellora, Torino (IT); Luca Greco, Torino (IT); Diego Voglione, Torino (IT)

(73) Assignee: FPT Industrial S.p.A., Torino (IT)

(21) Appl. No.: 14/601,452

(22) Filed: Jan. 21, 2015

(30) Foreign Application Priority Data
Jan. 22, 2014 (IT) MI2014A000083

(51) Int. Cl. F01P 5/12; F01N 5/04; F02B 29/04; F02C 6/12

(52) U.S. Cl. CPC F01P 5/12; F02C 6/12; F01N 5/04; F02B 29/04; F05D 2220/40

(57) ABSTRACT

A system for pressurizing a cooling circuit of an internal combustion engine equipped with a turbocompressor unit. The turbocompressor has a turbine arranged on an exhaust line of the exhaust gas of the internal combustion engine and a compressor arranged on the intake line internal combustion engine. The internal combustion engine comprises a cooling circuit comprising an expansion tank connected, by a pneumatic pipe, to a point of the intake line downstream of the compressor. The pneumatic pipe comprises a mechanical valve, adapted to open and to close said pneumatic pipe in relation to a differential pressure between a point upstream and a point downstream of the mechanical valve itself.

### BACKGROUND OF THE INVENTION

1. Field of the Invention

The present invention relates to the field of cooling circuits of internal combustion engines, and in particular to the field of managing the internal pressure of the circuit by means of the compressed air generated by the turbocompressor, more specifically, by means of a mechanical valve, without the use of pressure sensors and related control units.

2. Description of the Related Art

Modern cooling circuits of internal combustion engines are equipped with expansion tank of the coolant. In such an expansion tank, part of the volume thereof is filled with air, and in which there is usually accommodated a safety valve which allows gas/vapour to be released into the outside environment when a predetermined pressure value measured in the expansion tank is exceeded.

The circulation and the pressurization of the coolant in the circuit is ensured by a hydraulic pump.

By using pumps with variable flow rates, that is capable of auto-adjustment on the basis of the temperature of the coolant, it may happen that the cooling circuit has points in which the pressure decreases to the point of allowing cavitation phenomena to occur.

Such phenomena determine a rapid corrosion of the walls of the cooling circuit inside the internal combustion engine, with serious damage to the engine.

Such phenomena are associated with the pressure of the circuit, but also with the temperature of the coolant.

Various solutions are known which are based on the emission of air into the circuit, so as to increase the pressure in the circuit in order to avoid such cavitation problems.

JP19800169161 shows a solution in which piezoelectric sensors are arranged along the cooling circuit to detect cavitation phenomena. When these phenomena are detected, air from the radiator fan is blown into the circuit, in quantity proportional to the intensity of the cavitation phenomenon detected.

US2005061264 shows a solution for pressurizing the cooling circuit by means of detecting a level of coolant inside the expansion tank. Therefore, when the liquid rises past a predetermined level, air is introduced into the tank. A preferred variant shows the further use of a pressure sensor accommodated inside the expansion tank and processing means which control the emission of compressed air into the expansion tank also on the basis of the pressure measured in the expansion tank. The compressed air may be taken from the intake pipe of the internal combustion engine, downstream of the compressor.

U.S. Pat. No. 6,666,175 shows another solution in which the cooling circuit is pressurized by the supercharging compressor and in which the pressurization is controlled by means of a spring valve or by means of a servovalve.

### SUMMARY OF THE INVENTION

The object of the present invention is to show a system for pressurizing a cooling circuit of an internal combustion engine operated by mechanical valves, that is not servo controlled, based on bleeding compressed air from the intake line of the internal combustion engine between the compressor and the intake manifold.

The object of the present invention is a system for pressurizing a cooling circuit of an internal combustion engine equipped with a turbocompressor unit, in accordance with claim 1.

The accompanying claims describe preferred embodiments of the invention, thus forming an integral part of the present description.

### BRIEF DESCRIPTION OF THE DRAWINGS

Further objects and advantages of the present invention will become apparent from the detailed description below of an embodiment thereof (and two variants thereof) and from the accompanying drawings given by mere way of non-limiting example, in which:

FIG. 1 indicates a schematic diagram of the system, which is the object of the present invention,

FIG. 2 includes examples of mechanical valves, which are part of the diagram in FIG. 1.

The same numbers and the same reference letters in the figures identify the same elements or components.

### DETAILED DESCRIPTION OF THE EMBODIMENTS

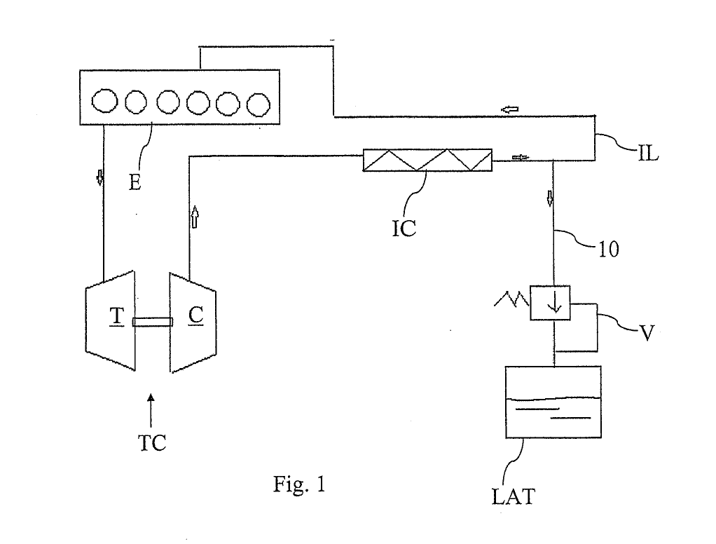

With reference to FIG. 1, an internal combustion engine E is shown equipped with a turbocompressor unit TC, in which the turbine is arranged on the exhaust line of the exhaust gas of the internal combustion engine, while compressor C is arranged on the intake line IL of the internal combustion engine.

Arranged on the intake line, between compressor C and the intake manifold is also an intercooler IC.

The internal combustion engine E has a cooling circuit (not shown), which is connected to a closed expansion tank LAT, which is partly full of coolant and partly full of air.

A safety valve is generally connected to the upper part of tank LAT so as to release vapour into the external environment when a predetermined pressure threshold is exceeded.

A pneumatic pipe 10 connects the intake line IL with the upper part of the expansion tank LAT. And precisely a point on the line downstream of compressor C.

The opening and closing of such a pipe 10 is achieved by a mechanical valve V, preferably a spring valve, that is without any electrical slave.

Such a valve opens pipe 10 so that compressed air flows into the expansion tank LAT, when it detects a predetermined difference in pressure between a point upstream and a point downstream of the valve itself, where “upstream” and “downstream” refer to the circulation direction of the compressed air from the intake line IL to the expansion tank LAT.

Preferably, the mechanical valve V is set on the basis of the maximum supercharging pressure of the turbocompressor unit.

Therefore, any adjustment of the pressurization of tank LAT is performed mechanically, without the aid of control means.

A significant role is played in system stability by the fact that the compressed air is bled downstream of the intercooler, that is between the intercooler and the intake manifold IC of the internal combustion engine E.

Indeed, the emission of cooled air avoids the formation of vapours which would immediately harden upon opening of the safety valve generally found on the expansion tank LAT.

Preferably said mechanical valve is a three-way valve.

More specifically, also when the valve appears from the outside as a two-way valve, a third port is integrated in the valve and is connected to one of the other ports to measure the pressure upstream or downstream of the valve. In other words, the third port controls the opening of the valve.

Preferably, the third port is connected with the outlet port of the valve, that is the port with the lower pressure, directly connected with the expansion tank.

Preferably, a small air expansion reservoir 11 is integrated in valve V so as to allow a preventive expansion of the compressed air before and during the emission thereof into the expansion tank LAT.

Therefore, reservoir 11 is in pneumatic communication with the pneumatic pipe 10.

Advantageously, due to the implementation of reservoir 11, it is possible to modulate the opening and closing of valve V with greater precision, without taking the risk of subjecting the expansion tank to too high an increase in pressure.

Additionally, reservoir 11 cooperates synergistically with the bleeding downstream of the intercooler, because the albeit modest expansion of the compressed air inside reservoir 11 leads to a further lowering of the temperature of the compressed air introduced into the expansion tank LAT.

Preferably, the air expansion reservoir 11 has an inner volume of about 13 l. ⅕- 1/10 of the (upper) part of inner volume of the expansion tank LAT occupied by air.

According to another preferred variant of the invention, the system comprises a valve 10, apparently a two-way valve, in which the third port is connected with one of the other two ports, having an air expansion reservoir directly integrated in the valve body.

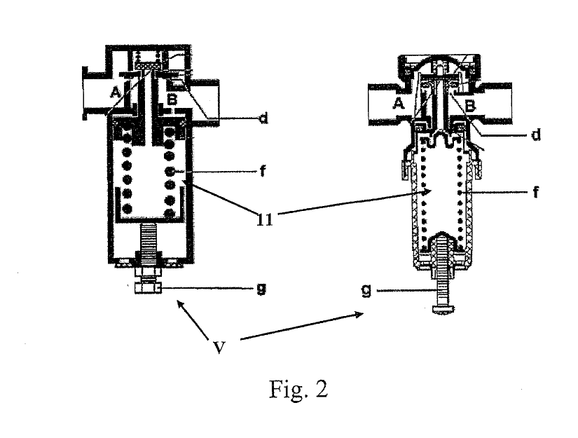

FIG. 2 shows a purely indicative example of a Wabco® valve, which is particularly suitable for the implementation of the present invention.

Such valves are equipped with two gates A and B and both gates B integrate two gates, a control gate d and one for the passage of the compressed air.

The aforesaid air expansion reservoir 11 is made inside the valve body. In particular, such a reservoir is stretchable by means of a membrane/movable piston loaded through a helical thrust spring f, which can be adjusted by means of a screw g which is accessible outside the valve body and is arranged in axial position with respect to the helical spring.

Embodiment variations to the non-limiting example described are possible, without however departing from the scope of protection of the present invention.

The person skilled in the art is able to achieve the object of the invention from the aforesaid description without introducing further construction details. The elements and features disclosed in the various preferred embodiments may be combined with one another without however departing from the scope of protection of the present application. Unless specifically excluded in the detailed description, what is described in the description of the state of the art is to be considered in combination with the features of the present invention, thus forming an integral part of the present invention.

What is claimed is:

1. System for pressurizing a cooling circuit of an internal combustion engine equipped with a turbocompressor unit, wherein the turbocompressor has a turbine arranged on an exhaust line of the exhaust gas of the internal combustion engine and a compressor arranged on the intake line of the internal combustion engine; the internal combustion engine comprising a cooling circuit comprising an expansion tank connected, by a pneumatic pipe, to a point of the intake line downstream of said compressor, and wherein said pneumatic pipe comprises a mechanical valve, adapted to open and to close said pneumatic pipe in relation to a differential pressure between a point upstream and a point downstream of the mechanical valve itself.

2. System according to claim 1, wherein said mechanical valve is set according to a maximum supercharging pressure of the turbocompressor unit.

3. System according to claim 1, wherein said mechanical valve is of the three-way type, wherein
a first port is connected directly with the intake line,
a second port is connected with the expansion tank,
a third port is connected with one of the first or second port, to control the opening/closing of the mechanical valve.

4. System according to claim 1, wherein said mechanical valve comprises an air expansion reservoir integrated in the body of the mechanical valve itself.

5. System according to claim 1, wherein said intake comprises an intercooler downstream of said compressor and wherein said pneumatic pipe is connected to said intake line downstream of said intercooler.

6. Terrestrial vehicle comprising an internal combustion engine cooled by means of a cooling circuit and equipped with a turbocompressor unit characterized in that it comprises a pressurizing system of the cooling circuit according to claim 1.
